(19) United States
(12) Patent Application Publication
(10) Pub. No.: US 2020/0265128 A1
(43) Pub. Date: Aug. 20, 2020

(54) ELECTRONIC MODULE ACCESS CONTROL

(71) Applicant: HEWLETT PACKARD ENTERPRISE DEVELOPMENT LP, Houston, TX (US)

(72) Inventors: Kevin LEIGH, Houston, TX (US); Sunil GANTA, Houston, TX (US); John NORTON, Houston, TX (US)

(73) Assignee: Hewlett Packard Enterprise Development LP, Houston, TX (US)

(21) Appl. No.: 15/774,375

(22) PCT Filed: Jun. 30, 2016
(86) PCT No.: PCT/US2016/040473

§ 371 Date: May 8, 2018

(51) Int. Cl. G06F 21/32; G07C 9/00; G06K 7/10; G06F 21/35

(52) U.S. Cl. CPC G06F 21/32; G06F 21/35; G06K 7/10366; G07C 9/00563

(57) ABSTRACT

An example security device is provided herein. The security device includes a lock mechanism and a control mechanism. The lock mechanism is associated with an electronic module. The control mechanism is communicatively coupled to the lock mechanism and the electronic module. The control mechanism uses an authorization mechanism to determine when to activate the lock mechanism and when to inactivate the lock mechanism.

### BACKGROUND

Computing systems may include a system board with a number of socket connectors to couple module boards to the system board. The module boards can be hot-pluggable transceiver modules used for network data communications. The system board may be behind a faceplate.

### BRIEF DESCRIPTION OF THE DRAWINGS

Non-limiting examples of the present disclosure are described in the following description, read with reference to the figures attached hereto and do not limit the scope of the claims. In the figures, identical and similar structures, elements or parts thereof that appear in more than one figure are generally labeled with the same or similar references in the figures in which they appear. Dimensions of components and features illustrated in the figures are chosen primarily for convenience and clarity of presentation and are not necessarily to scale. Referring to the attached figures:

FIG. 1 illustrates a block diagram of a security device according to an example;

FIG. 2 illustrates a schematic view of the security device of FIG. 1 according to an example;

FIG. 3 illustrates a block diagram of a system to securely control access to an electronic module according to an example;

FIG. 4 illustrates a top view of the system of FIG. 3 according to an example;

FIG. 5 illustrates a side view of the system of FIG. 3 according to an example;

FIGS. 6-11 illustrate cross-sectional views of the system of FIG. 3 according to examples;

FIG. 12 illustrates a schematic view of a portion of the system of FIG. 3 according to an example; and

FIG. 13 illustrates a flow chart of a method to access an electronic module according to an example.

### DETAILED DESCRIPTION

In the following detailed description, reference is made to the accompanying drawings which form a part hereof, and in which is depicted by way of illustration specific examples in which the present disclosure may be practiced. It is to be understood that other examples may be utilized and structural or logical changes may be made without departing from the scope of the present disclosure.

Managing access to electronic modules in computing systems is important in certain situations. Many electronic modules can be easily installed and hot-plugged, but the computing system may be vulnerable to non-secure electronic modules being connected to the computing system. For example, the access controls may restrict operation or functionality of the electronic module and/or manage removal of the physical module. Therefore, providing a managed method to access electronic modules using authorization provides an option for secure control of the electronic module.

A security device to control access to an electronic module is provided herein. The security device includes a lock mechanism and a control mechanism. The lock mechanism is associated with an electronic module. The control mechanism is communicatively coupled to the lock mechanism and the electronic module. The control mechanism uses an authorization mechanism to determine when to activate the lock mechanism and when to inactivate the lock mechanism.

As used herein, the term “access” refers to enabling or disabling communication and/or functionality between an electronic module and a system board or other electronic modules. For example, the device may be physically or communicatively locked or unlocked.

As used herein, the phrase “electronic module” refers to a physical subcomponent of an electronic system with multiple subcomponents, such as a server module, a storage module, and/or a networking module.

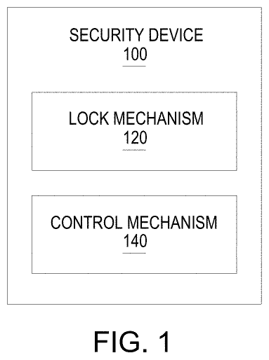

FIG. 1 illustrates a block diagram of a security device 100 according to an example. The security device 100 controls access to an electronic module. The security device 100 includes a lock mechanism 120 and a control mechanism 140. The lock mechanism 120 is associated with the electronic module. The control mechanism 140 is communicatively coupled to the lock mechanism 120 and the electronic module. The control mechanism 140 uses an authorization mechanism to determine when to activate the lock mechanism 120 and when to inactivate the lock mechanism 120.

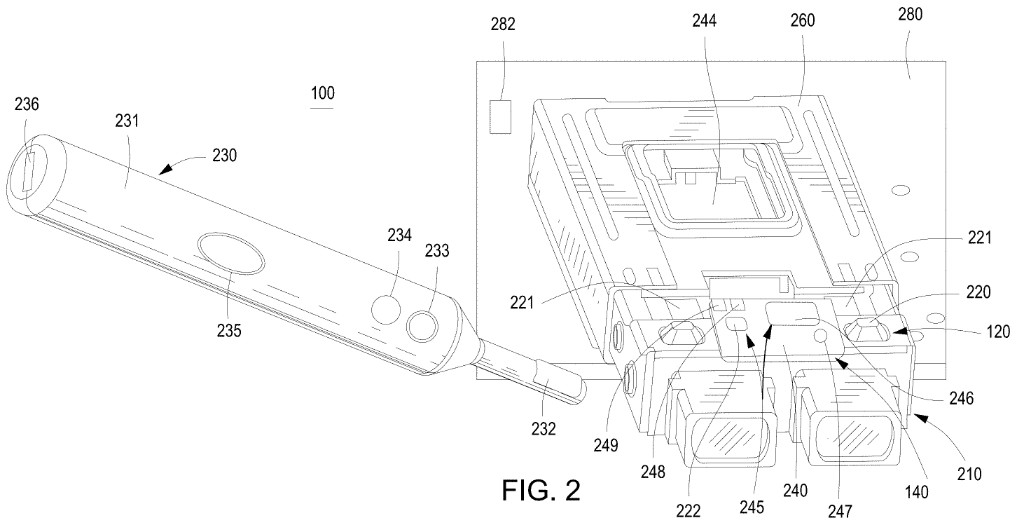

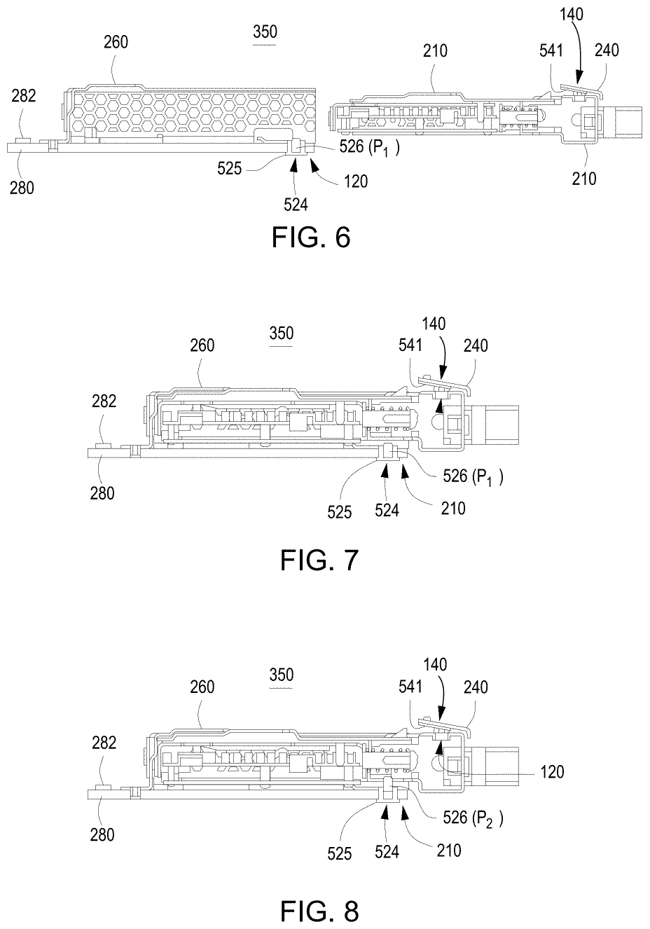

FIG. 2 illustrates a schematic view of the security device 100 of FIG. 1 according to an example. In an example, the security device 100 may be utilized with an electronic module 210 inserted into a cage 260. An example of the lock mechanism 120 of the security device 100 includes a physical lock described in FIGS. 5-11; however, other lock mechanisms 120, such as mechanisms to restrict operation of the electronic module 210 may be used. For example, the physical lock may physically secure the electronic module 210 to the cage 260 and/or a system board 280. The lock mechanism 120 may also deny access to or restrict operation of the electronic module 210.

An example of the control mechanism 140 of the security device 100 is illustrated to include a control panel 240 and a module board 244 communicatively connected to a control logic 282. The control logic 282 may be present on the system board 280 or on another system board via a network interface on the system board 280. For example, the system board 280 may include the control logic 282 that communicates with the control mechanism 140. A control panel board is located under the control panel 240. The control panel board is electrically coupled to the system board 280, via a blind mate connector (not shown in FIG. 2). The control panel 240 is what a user would see when looking at the electronic module 210. The control panel 240 may include a biometric sensor 246, an access request button 222, and indicators 248, 249. The biometric sensor 246, the access request button 222, and the indicators 248, 249 are electrically coupled to a control panel board (not shown) under the control panel 240 which in turn is electrically coupled to the module board 244. The indicators 248, 249 may provide status information, such as, the lock mechanism's 120 state and/or state of the electronic module 210.

The module board 244 uses an authorization mechanism 245 to obtain data to determine the lock mechanism's 120 state and when to change the state. The authorization mechanism 245 may include a sensor and/or a button. For example, the authorization mechanism 245 includes at least one authorization device selected from the biometric sensor 246 and the contactless tag reader 247. The authorization mechanism 245 may be initiated using the access request button 222 the biometric sensors 246, and/or the contactless tag reader 247.

FIG. 2 illustrates the access request button 222, the biometric sensor 246 and the contactless tag reader 247. For example, the access request button 222 may be a momentary push button. The biometric sensor 246 may be a fingerprint sensor that controls access to the electronic module 210 based on receiving an authorized fingerprint. The contactless tag reader 247 may be a near field communication (NFC) tag reader or radio-frequency identification (RFID) tag reader that will control access based on an authorized key being placed in proximity to the contactless tag reader. There may also be a physical or manual lock 220 on the electronic module 210 that may physically release the electronic module 210; however, the manual lock 220 may only operate if the authorization mechanism 245 indicates that release of the electronic module 210 is authorized. For example, the physical lock 220 may include at least one latch 221 that engages with the cage 260 when the electronic module 210 is fully inserted inside the cage 260. FIG. 2 illustrates an example that includes two physical locks 220 and latches 221; however, examples may include at least one physical lock 220 and latch 221 and may include more than two depending on the security device 100.

The security device 100 may also include an access mechanism 230 programmed to communicate with the control mechanism 140 and to provide authorization data to the control mechanism 140. For example, the access mechanism 230 may be a contactless tag 232, such as an RFID or NFC tag. The contactless tag 232, for example, may communicate with the contactless tag reader 247 on the electronic module 210. An example access mechanism 230 is illustrated as a key fob 231 that includes not only the contactless tag 232, but also includes indicators, such as light-emitting diodes (LED) 233, 234; a control button 235, and a programming device interface 236.

The key fob 231 may be used to securely lock and unlock the electronic module 210. For example, when a key fob 231 is used as the initiator, the key fob 231 is placed in proximity to the electronic module 210 to allow the contactless tag 232 to initiate communication with the contactless tag reader 247 on the electronic module 210. Alternatively, the electronic module 210 may be the initiator, and the electronic module's 210 contactless tag reader 247 reads the contactless tag 232 of the key fob 231. For example, electronic module 210 may initiate locking and unlocking through the access request button 222 that activates the contactless tag reader 247 or a higher level management mechanism. The access request button 222 allows another level of identification, in addition to the key fob's 231 proximity to the electronic module 210, to identify and remove a specific electronic module 210.

When a key fob 231 is used, the distance and actual proximity of the key fob 231 and the electronic module 210 will depend on the particular security device 100 and contactless tag 232 technology. Multiple electronic modules 210 may be adjacent to one another and the same key fob 231 may be used for one, two, or all of the electronic modules 210 depending on the settings and the type of key fob 231. For example, a key fob 231 using NFC technology may be able to distinguish one electronic module from another, while RFID may not be able to distinguish the electronic modules in close proximity. In examples where a key fob 231 with RFID is used, the access request button 222 allows specific electronic modules 210 to be identified, removed, installed, or to be operational, where multiple electronic modules may be authorized by the key fob 231.

The key fob 231 and electronic module 210 establish a dedicated and secured communication channel by exchanging information. In an example, the key fob's 231 contactless reader 247 reads the contactless tag 232 of the electronic module 210. The key fob 231 may be pre-programmed with unique identifiers (UID), such as, a UID of the key fob 231 and the UID associated with the electronic module 210. For example, the UID may be public key. The key fob 231 provides a fob public key to the electronic module 210 and requests acknowledgement from the electronic module 210. Similarly, the electronic module 210 may be pre-programmed with UIDs, such as, a UID of the electronic module 210 and the UID associated with the key fob 231. The electronic module 210 provides a module public key to the key fob 231 and requests acknowledgement from the key fob 231. After the key fob 231 and the electronic module 210 exchange their public keys and acknowledgements, each decrypts with its own private key, to establish a dedicated and secured communication channel therebetween.

After the dedicated and secure communication channel is established, the UID indicators 248, 233 on the electronic module 210 and the key fob 231 may blink. The lock/unlock indicators 249, 234 may also be blinking the same color as each other. For example, the indicators 234, 249 are amber for lock and green for unlock. Depressing the lock/unlock button (e.g., control button 235) once on the key fob 231 will lock the electronic module 210 if it was unlocked or will unlock the electronic module 210 if it was locked. The lock/unlock indicators 234, 248 may then illuminate to indicate the appropriate lock or unlock state of the electronic module 210.

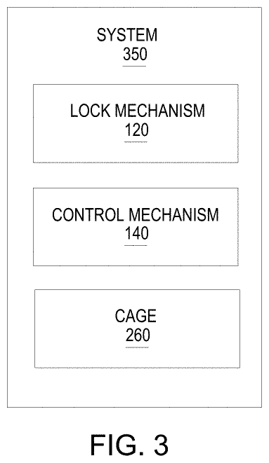

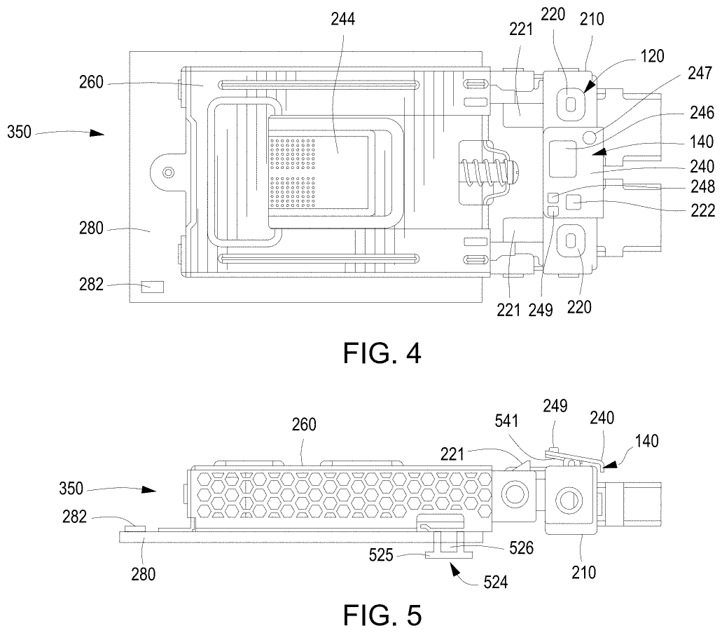

FIG. 3 illustrates a block diagram of a system 350 to securely control access to an electronic module according to an example. FIGS. 4-5 illustrate examples of the system 350. FIG. 4 illustrates a top view of the system of FIG. 3 according to an example. FIG. 5 illustrates a side view of the system of FIG. 3 according to an example. Referring to FIGS. 3-5, the system 350 includes a cage 260, a lock mechanism 120, and a control mechanism 140. The cage 260 is mechanically coupled to a system board 280. The cage 260 receives an electronic module 210. The lock mechanism 120 engages with the electronic module 210. For example, the lock mechanism 120 may be a secure lock pin 524 that extends through the system board 280 and into the cage 260 and engages with the electronic module 210. In another example, the lock mechanism 120 may be a secure lock pin 524 that located on the top side of the system board 280 and extends into the cage 260 and engages with the electronic module 210.

The control mechanism 140 is communicatively connected to the lock mechanism 120 and the electronic module 210 to control movement of the lock mechanism 120 between a locked state and an unlocked state. The control mechanism 140 includes a control panel board 541 coupled to the electronic module 210 and a module board 244 electrically connected to the system board 280 to manage communication between the electronic module 210 and the system board 210. The control panel board 541 is where the access request button 222, the indicators 248, 249 and the biometric sensor 246 are electrically coupled to. The control panel board 541 may include logic to consolidate the signals to and from the access request button 222, the indicators 248, 249, the biometric sensor 246, and the tag/reader. The control panel board 541 is attached below the control panel 240.

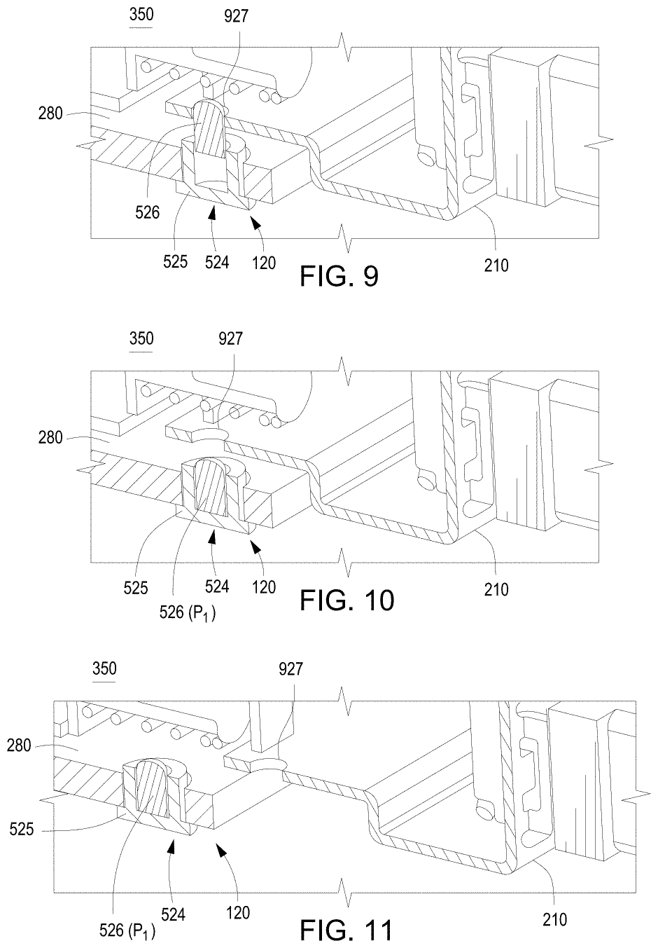

FIGS. 6-11 illustrate cross-sectional views of the system of FIG. 3 according to an examples. As illustrated in FIGS. 6-8, the cross-sectional view is of the side of the system 350 with a physical lock mechanism 120 visible. The lock mechanism 120 may include a secure lock pin 524 that includes a pin channel 525 and a moveable pin 526. The pin channel 525 is attached to the system board 280 and receives the moveable pin 526. The moveable pin 526 may move between a first position or unlocked position P₁, and a second position or locked position P₂. In the first position or unlocked position P₁, the secure lock pin 524 allows the electronic module 210 to be installed and removed from the cage 260. In the second position or locked position P₂, the secure lock pin extends through the cage 260 and engages with a secure lock on the electronic module 210. Movement of the secure lock pin 524 and the electronic module 210 are illustrated in FIGS. 6-11. The illustrated examples provide details regarding how the electronic modules 210 may be locked and unlocked and how the electronic modules 210 may be inserted and removed based on the lock and unlock states.

FIG. 6 illustrates the cage 260 attached to the system board 280 and the electronic module 210 uninstalled. The secure lock pin 524 is in a first or unlocked position P₁. FIG. 6 also illustrates a side view of the control panel 240 with the control panel board 541 thereunder. FIG. 7 illustrates the electronic module 210 fully inserted with the secure lock pin 524 in the first or unlocked position P₁. The position illustrated in FIG. 7 may occur 1) after the electronic module 210 is fully installed, but before the electronic module 210 is locked into place, or 2) after the electronic module is unlocked and is ready to be removed. The system 350 may not allow the electronic module 210 to be fully operational when the secure lock pin 524 is in the first or unlocked position P1. FIG. 8 illustrates the electronic module fully inserted into the cage 260 with the secure lock pin 524 in a second or locked position P₂. In the second or locked position P₂, the electronic module 210 is securely attached to the system board 280 and enables the electronic module 210 to be retained in a secure position. The system 350 may allow the electronic module 210 to be fully operational only when the secure lock pin 524 is in the second or locked position P2.

FIG. 9 illustrates an enlarged view of the secure lock pin 524 in the second or locked position P₂, with the electronic module 210 fully inserted into the cage 260. In the fully inserted position, the secure lock 927 on the electronic module 210 aligns with the secure lock pin 524 attached to the system board 280. When the moveable pin 526 extends from the channel 525, the moveable pin 526 engages with the secure lock 927 to retain the electronic module 210 in a physically locked position. Once in the locked position, the secured lock pin 524 may continue to engage with the secure lock 927 even when power is not present in the system. In one example, the secured lock pin 524 may use an auxiliary power supply to maintain its position, if there is a power failure in the system 350. In another example, the secured lock pin 524 may be a bi-stable locking device, i.e., the secured lock pin 524 does not change its position upon power failure in the system 350. In order to move the moveable pin 526 from the second or locked position P₂, to the first or unlocked position P₁, the key fob 231, the access request button 222 on the electronic module 210, and/or another access device may initiate the movement.

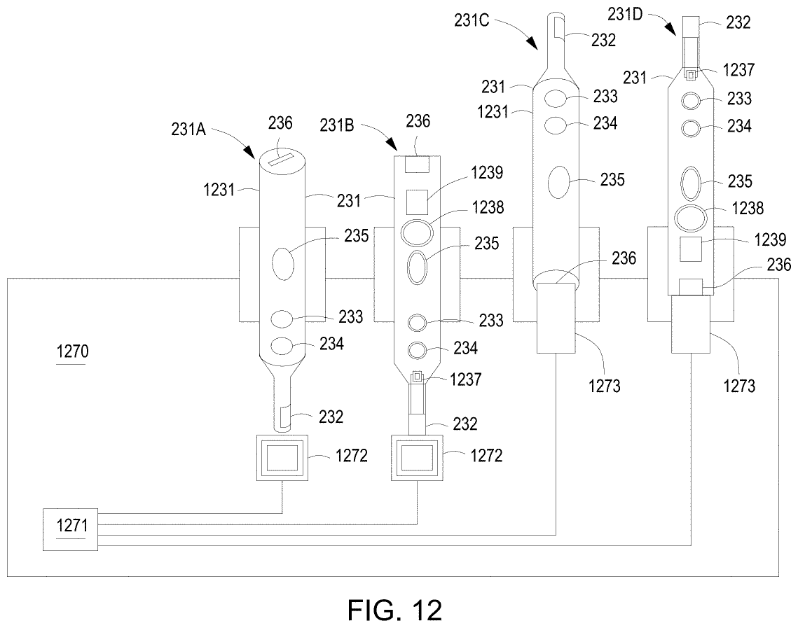

FIG. 10 illustrates an enlarged view of the secure lock pin 524 in the first or unlocked position P₁, with the electronic module fully inserted into the cage 260. In the first or unlocked position P₁, the moveable pin 526 retracts into the channel 525 and does not engage with the secure lock 927. As illustrated in FIG. 10, the moveable pin 526 remains aligned with the secure lock 927 since the electronic module 210 is fully inserted into the cage 260. In this position, the electronic module 210 may be removed, as illustrated in FIG. 12 or locked, as illustrated in FIG. 10. In order to move the moveable pin 526 back into the second or locked position P₂, the key fob 231, the access request button 222 on the electronic module 210, and/or another access device may initiate the movement of the moveable pin 526.

FIG. 11 illustrates the electronic module 210 partially inserted into the cage 260 with the secure lock pin 524 remaining in a first or unlocked position P₁. The moveable pin 526 is illustrated retracted into the channel 525 and does not engage with the secure lock 927. As illustrated in FIG. 11, the electronic module 210 is removed from the cage 260 or inserted into the cage 260 since the secure lock 927 is not engaging with the moveable pin 526.

FIG. 12 illustrates a schematic view of a portion of the system 350 of FIG. 3 according to an example. The system 350 may also include a secure programming and charging station 1270 associated with the electronic module 210 that provides authorization data to an access mechanism 230. FIG. 12 illustrates an example of four bays to illustrate two access mechanisms 230 as key fobs 231A-D. Two key fobs 231B, 231D are illustrated with covers removed, and two key fobs 231A, 231C are illustrated with covers installed. The key fobs 231A-D may include a housing 1231, a contactless tag/antenna 232, a UID indicator 233, a lock/unlock indicator 234, a lock/unlock button (e.g., control button 235), a programming device interface 236, a contactless reader/antenna 1237, a rechargeable power source 1238, and a key fob control logic chip 1239. The housing 1231 encases or surrounds the components 232-236, 1237-1239. The contactless tag/antenna 232 may be programmed with authorized electronic module 210 identification data by the key fob control logic chip 1239. In another example, indicators 233, 234 on the key fob 231 may be used to indicate the charging and programming statuses of the key fob 231.

The programming device interface 236 connects to an interface connector to charge the rechargeable power source 1238 of the key fob 231 and/or transmit data to program or adjust settings of the key fob 231 via the key fob control logic chip 1239. The rechargeable power source 1238 powers the key fob when it is not connected to an interface connector. The rechargeable power source 1238 may be a rechargeable battery that is charged through the programming device interface 236. The key fob control logic chip 1239 interfaces with the secure programming station control logic via the interface connector 1273. The key fob control logic chip 1239 programs the key fob 231 and enables settings and/or adjustments to be made to the key fob 231 to control access to at least one electronic module 210.

The key fob 231 may be programmed with authorization data for electronic modules 210 using the secure programming and charging station 1270, for example located on a programming station bench in a production factory. The secure programming and charging station 1270 may include a secure programming station control logic, such as, a programming control logic chip 1271 that is connected to a tag writer and antennae 1272 or an interface connector 1273, e.g., a USB connector port. The secure programming and charging station 1270 may be used in multiple ways. For example, the key fob 231 may be placed in proximity to a corresponding contactless tag writer of a secure programming and charging station 1270 to program the contactless tag 232 of the key fob 231 when using a contactless tag writer and antennae 1272. Similarly, when using an interface connector, the contactless tag 232 and/or control logic chip 1239 may be programmed by plugging the programming device interface 236 into the interface connector 1273, e.g., USB connector. Verification that a fully charged and programmed key fob 231 is correctly programmed may be accomplished by the tag reader 1237 and the antennae 1272.

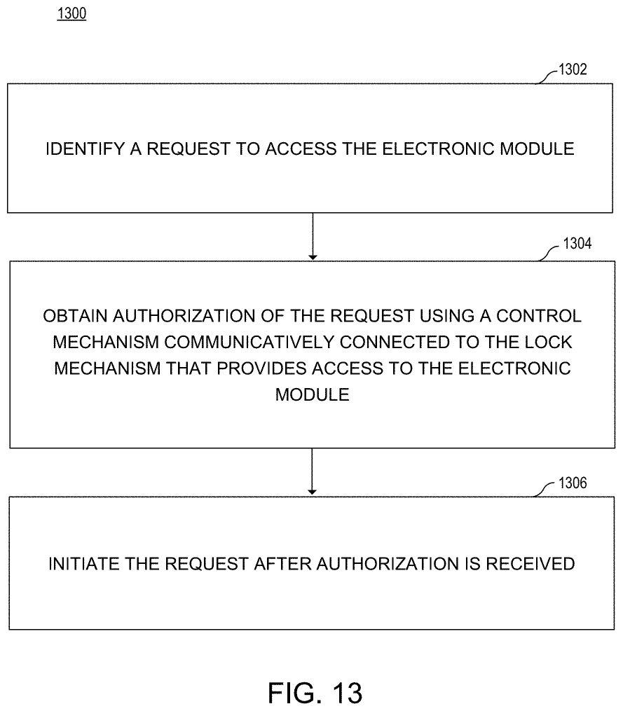

FIG. 13 illustrates a flow chart 1300 of a method to access an electronic module according to an example. In block 1302, a request to access the electronic module is identified. The electronic module includes a physical subcomponent of an electronic system. The request may be made using a physical button or an electronic component. The physical button or electronic component may be physically attached to the electronic module or communicatively connected thereto. For example, the request may be made via a biometric sensor, a contactless tag reader, an access request button, a key fob, and an access request button, such as an activation request button and a removal request button. The request may include a call to engage or release a physical lock, such as the secure lock pin. The request may also include a call to allow or limit operation of the electronic module using software or firmware methods. The request may also be associated with the electronic module by being physically attached to the electronic module or communicatively connected to the electronic module. Prior to or after the request is made, the system may confirm the connection and/or status of the electronic module, i.e., inserted, removed, locked, or operating; and the state of the lock mechanism, i.e., locked or unlocked.

In block 1304, an authorization of the request is obtained using a control mechanism communicatively connected to the lock mechanism that provides access to the electronic module. The authorization of the request may include confirming the request is properly linked to the electronic module and the request contains credentials associated with the electronic module. The credential may be obtained from an authorization mechanism, such as, a biometric sensor and/or a contactless tag reader.

In block 1306, the request is initiated after authorization is received. The request may include engaging or releasing a physical lock, such as the secure lock pin. The request may also control access to the electronic module by enabling or disabling operation of the electronic module using software or firmware methods. Before authorization and/or initiating the request, the method may also verify the status of the electronic module and/or the secured lock. For example, the method may verify that the secured lock is actuated when a request to remove the electronic module is identified. Similarly, the method may verify that secured lock is not actuated when a request to lock is received. Additional verifications may also be executed prior to authorization and/or initiation of the request.

Although the flow diagram of FIG. 13 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. All such variations are within the scope of the present disclosure.

The present disclosure has been described using non-limiting detailed descriptions of examples thereof and is not intended to limit the scope of the present disclosure. It should be understood that features and/or operations described with respect to one example may be used with other examples and that not all examples of the present disclosure have all of the features and/or operations illustrated in a particular figure or described with respect to one of the examples. Variations of examples described will occur to persons of the art. Furthermore, the terms “comprise,” “include,” “have” and their conjugates, shall mean, when used in the present disclosure and/or claims, “including but not necessarily limited to.”

It is noted that some of the above described examples may include structure, acts or details of structures and acts that may not be essential to the present disclosure and are intended to be examples. Structure and acts described herein are replaceable by equivalents, which perform the same function, even if the structure or acts are different, as known in the art. Therefore, the scope of the present disclosure is limited only by the elements and limitations as used in the claims.

What is claimed is:

1. A method to control access to an electronic module comprising:
identifying a request to access the electronic module, the electronic module includes a physical subcomponent of an electronic system;
obtaining authorization of the request using a control mechanism communicatively connected to a lock mechanism that provides access to the electronic module; and
initiating the request after authorization is received.

2. The method of claim 1, wherein the request to access the electronic module includes enabling or disabling operation of the electronic module.

3. The method of claim 1, further comprising verifying that the lock mechanism is actuated when a request to remove the electronic module is identified.

4. The method of claim 1, wherein the authorization of the request includes:
confirming the request is linked to the electronic module, and
confirming the request contains credentials associated with the electronic module.

5. The method of claim 4, wherein the credentials are obtained from at least one authorization mechanisms selected from a biometric sensor and a contactless tag reader.

6. The method of claim 1, wherein the request is made via at least one mechanisms selected from a biometric sensor, a contactless tag reader, and an access request button.

7. A system to securely control access to an electronic module, the system comprising:
a cage connected to a system board, the cage to receive an electronic module;
a lock mechanism to engage with the electronic module; and
a control mechanism communicatively connected to the lock mechanism and the electronic module to control movement of the lock mechanism between a locked state and an unlocked state.

8. The system of claim 7, wherein the lock mechanism includes a secure lock pin attached to the system board that extends through the cage and engages with a secure lock on the electronic module.

9. The system of claim 7, wherein the control mechanism includes a control panel coupled to the electronic module and a module board electrically connected to the system board.

10. The system of claim 7, wherein the control mechanism further includes a control logic to manage communication between the electronic module and the system board.

11. The system of claim 7, further comprising an access mechanism associated with the electronic module that provides authorization data.

12. The system of claim 11, further comprising a secure programming and charging station to provide authorization data to the access mechanism.

13. A security device to control access to an electronic module that is a physical subcomponent of an electronic system, the security device comprising:
a lock mechanism associated with the electronic module and coupled to the electronic system; and
a control mechanism communicatively coupled to the lock mechanism and the electronic module, the control mechanism uses an authorization mechanism to determine when to activate the lock mechanism and when to inactivate the lock mechanism.

14. The security device of claim 13, wherein the authorization mechanism includes at least one authorization device selected from a biometric sensor and a contactless tag reader.

15. The security device of claim 13, further comprising an access mechanism programmed to communicate with the control mechanism and to provide authorization data to the control mechanism.
